(19) United States
(12) Patent Application Publication
(10) Pub. No.: US 2026/0276026 A1
(43) Pub. Date: Sep. 17, 2026

(54) QUICK INSTALL NUT

(71) Applicant: Globe Union Industrial Corp., Taichung City (TW)

(72) Inventor: Chao-Ta Yang, Taichung City (TW)

(21) Appl. No.: 19/561,447

(22) Filed: Mar. 9, 2026

(30) Foreign Application Priority Data
Mar. 11, 2025 (CN) 202520415879.X

(51) Int. Cl. F16B 37/08

(52) U.S. Cl. CPC F16B 37/0864

(57) ABSTRACT

A quick install nut is provided. The nut includes an engagement assembly, a tightening ring, and at least one reinforcing fixing member. The engagement assembly consists of a main body and at least one movable member mounted to the main body. The movable member is pressed and moved radially so that a thread fastener inserted through an insertion slot inside the main body is engaged and positioned. The tightening ring is elastically pressed so that the movable member is driven to move radially. The reinforcing fixing member is inserted through the main body to be threaded with the tightening ring. The reinforcing fixing member is further tightened to protrude from the tightening ring for providing tightening effect and enhancing fastening between the nut and the threaded fastener when the threaded fastener is threaded and positioned. Therefore, easy, fast, secure and durable installation of the quick install nut is achieved.

### FIELD OF THE INVENTION

The preset invention relates to a nut, especially to a quick install nut able to be installed and operated quickly.

### BACKGROUND OF THE INVENTION

In many devices, equipment, or accessories, threaded parts with long threads including threaded rods, bolts, and threaded pipes are needed and often used in combination with nuts for threaded fastening. In many cases, the nut needs to be rotated and moved a long distance along the threaded part for fastening. This gives rise to some problems such as long time of thread engagement and low installation and operation efficiency. A limited installation and operation space goes against the rotation of the nut on the threaded part. And a force for rotating the nut is even difficult to be applied to the nut. Thus tightness of the nut on the threaded part is affected.

In order to overcome shortcomings of the conventional nut mentioned above, a quick tightening nut is provided in Pub. No. CN 206738362 U. The nut includes a nut body provided with a threaded hole and a through hole. An axis of the threaded hole is vertical while an axis of the through hole is tilted. The axis of the threaded hole and the axis of the through hole are co-planar and an angle between them is an acute angle. A part of threads in the threaded hole is removed by the design of the through hole. While in use, a threaded rod is allowed to insert through the through hole and hold in place quickly after the threaded hole being tilted. Then the nut is returned to its original position and the nut body is fastened on the threaded rod through the threaded hole. Thereby the nut is installed quickly.

However, the above design of the nut still has certain shortcomings. For example, the threaded hole is completely enclosed in the nut body so that internal threads on an inner surface of the threaded hole can't be integrally formed by demolding. The complete threaded hole and the internal threads are formed by metal processing first. Then the through hole is formed by drilling to remove a part of the internal threads is remove. Thereby manufacturing of the nut is limited by the metal processing of the internal thread and the through hole and unable to be made from plastic materials by integral molding. The production efficiency of the nut is limited and reduction of production cost including materials is unattainable due to expensive metal materials used.

The nut is designed with the through hole to avoid direct contact with external threads of the threaded rod and allow quick insert of the threaded rod through the through hole. Yet the enclosed design of the through hole limits not only the space for relief of the threaded rod, but also the tilt angle of the nut. When the nut needs to be designed into a long and thin shape, no sufficient space for relief can be provided due to the above enclosed design of the through hole. Thus the external threads of the threaded rod may be in contact with or engaged with the internal threads of the threaded hole even with the maximum tilt angle. This results in that the tilted nut is unable to move on the threaded rod smoothly and the applications of the nut are significantly limited.

### SUMMARY

Therefore, it is a primary object of the present invention to provide a quick install nut able to be installed and fastened easily, quickly, and firmly with less effort. The quick install nut is especially suitable for installation and fastening of various bathroom fixtures and accessories including faucets and toilets.

In order to achieve the above object, a quick install nut according to the present invention includes an engagement assembly, a tightening ring, and at least one reinforcing fixing member.

The engagement assembly consists of a main body and at least one movable member. The main body is provided with an entrance end, an exit end, and an insertion slot defined in the main body for allowing a threaded fastener to insert through. The movable member is mounted adjacent to the entrance end of the main body and moved axially along the main body to be close to or away from the insertion slot.

The tightening ring is mounted and limited in the entrance end of the main body and maintained at an open position normally. While being abutted against and pressed on, the tightening ring is moved from the open position to a closed position axially along the main body, and positioned in the closed position in an elastically recoverable manner. Then the movable member is driven to move so that the threaded fastener is engaged in the engagement assembly tightly to form a threaded structure.

The reinforcing fixing member is inserted through the main body from the exit end to the entrance end and threaded with the tightening ring. The reinforcing fixing member can be turned and operated to protrude from the tightening ring and provide pressing and tightening effect when the tightening ring is in the closed position.

Preferably, in the main body of the quick install nut, a first side and a second side opposite to each other are mounted in the insertion slot. A first internal thread is disposed on a part of an inner peripheral wall of the insertion slot at the first side while an assembly groove is arranged at the inner peripheral wall of the insertion slot at the second side. The movable member is mounted and positioned in the assembly groove and provided with an abutted portion and at least one elastic deformation portion abutting against the assembly groove. When a force is applied to the abutted portion, the movable member is forced to move radially toward a center of the insertion slot and press against the threaded fastener. Thus the first internal thread of the main body is driven to move radially and engage with the threaded fastener. At the same time, the elastic deformation portion undergoes elastic deformation and generates an elastic recovery force.

Preferably, the tightening ring of the quick install nut consists of an opening, a tightening surface, and a resisting portion. The opening is corresponding to the insertion slot at the entrance end and allowing the threaded fastener to insert into the insertion slot therethrough. After the tightening surface being pressed, the tightening ring is moved axially from the open position to the closed position and the resisting portion is forced to abut against the abutted portion of the movable member. The first internal thread of the main body is further driven to engage with the threaded fastener.

Preferably, in the main body of the quick install nut, a curved groove used to define the assembly groove is disposed on the entrance end of the main body at the second side. The curved groove is provided with a notch corresponding to the center of the insertion slot and two positioning walls disposed on an inner side of the curved groove and located at two lateral sides of the notch correspondingly. The movable member is further provided with a tightening portion and two elastic pieces integrally extending from two lateral sides of the tightening portion correspondingly. The tightening portion is provided with a curved tightening wall which is formed on an inner side thereof and attached to and pressed against the external thread of the threaded fastener through the notch. The abutted portion is formed on an outer side of the tightening portion and the elastic pieces form the elastic deformation portions which are abutting against and positioned on the positioning walls correspondingly.

Preferably, a second internal thread is arranged at the curved tightening wall of the quick install nut and together with the first internal thread of the main body to engage with the external thread of the threaded fastener securely.

Preferably, the curved tightening wall of the quick install nut is a smooth surface and used for abutting and pressing against the external thread of the threaded fastener and forcing the first internal thread of the main body to engage with the external thread of the threaded fastener alone.

Preferably, the abutted portion of the movable member of the quick install nut is a slant. A resisting block is projecting from one side of the tightening ring corresponding to the main body and the resisting portion is disposed on the resisting block. The resisting portion is a slant closely attached to the slant of the abutted portion of the movable member.

Preferably, the abutted portion of the movable member of the quick install nut is a slant. A resisting block is projecting from one side of the tightening ring corresponding to the main body and the resisting portion is disposed on the resisting block. The resisting portion is a partial spherical surface.

Preferably, in the main body of the quick install nut, the entrance end is provided with a plurality of limit locking slots and at least one action wall. The tightening ring is provided with a plurality of elastic locking hooks and at least one elastic pin. After elastic compression and deformation, the elastic locking hooks are locked and limited in the limit locking slots correspondingly so that the tightening ring is limited to be moved between the open position and the closed position. The elastic pin is abutting against the action wall to undergo elastic deformation and generate an elastic recovery force when the tightening ring is moved from the open position to the closed position.

Preferably, in the tightening ring of the quick install nut, the elastic locking hooks are abutting against the limit locking slots of the main body to undergo elastic deformation and generate an elastic recovery force when the tightening ring is moved from the open position to the closed position.

Preferably, the main body of the quick install nut is provided with an engagement ring portion and a holding cylindrical portion extending from the engagement ring portion. The first internal thread, the assembly groove, and a part of the insertion slot are formed inside of the engagement ring portion while the rest part of the insertion slot is mounted inside the holding cylindrical portion and a holding surface is formed on the outside of the holding cylindrical portion for users to hold and operate.

Preferably, the main body of the quick install nut is provided with two insertion holes. The tightening ring is provided with two threaded holes corresponding to the insertion holes. Two tightening bolts which form the two reinforcing fixing members correspondingly are inserted through the insertion holes from the exit end of the main body to be threaded with the threaded holes of the tightening ring.

Preferably, two mounting slots opposite to each other are mounted in the main body of the quick install nut and extending from the exit end to the entrance end, and radially communicating with the insertion hole; One side of each of the mounting slots corresponding to the entrance end is connected to a base portion on which the insertion hole is formed. Two positioning recesses opposite to each other are arranged at the entrance end of the main body and the insertion hole is penetrating and extending to a bottom surface of the corresponding positioning recess. Two positioning bumps opposite to each other are projecting from one side of the tightening ring corresponding to the main body and mounted and positioned in the two positioning recesses correspondingly. The threaded holes are disposed on the positioning bumps correspondingly for being aligned with the insertion holes.

When the tightening ring of the quick install nut is in the open position, a rear end of the tightening bolt is not protruding from the tightening ring. When the tightening ring of the quick install nut is in the closed position, the tightening bolt is turned and tightened so that the rear end of the tightening bolt is protruding from the tightening ring for providing a pressing and tightening effect.

Preferably, the quick install nut further includes a tightening washer mounted and positioned on the tightening ring. After being turned, the reinforcing fixing member is inserted through protruding from the tightening ring to abut and press against the tightening washer. Then a pressing and tightening effect is generated by the tightening washer.

Preferably, the quick install nut further includes a tightening washer which is provided with an annular flange and the tightening surface is disposed on the annular flange. A positioning annular groove is defined in the annular flange for mounting and positioning the tightening washer therein. The threaded holes are formed on a bottom wall of the positioning annular groove.

Preferably, two nut positioning slots opposite to each other are concavely mounted to the bottom wall of the positioning annular groove and two through holes are penetrating the two nut positioning slots correspondingly. Two nuts are mounted and positioned in the nut positioning slots correspondingly with limited rotation and used to form the threaded holes.

Preferably, the tightening ring of the nut is in the open position under normal conditions. Thus the moveable member is affected by positioning of the elastic deformation portions on two lateral sides thereof to be away from the center of the insertion slot of the main body. During installation, the threaded fastener is allowed to be quickly inserted through a space between the first internal thread of the main body and the curved tightening wall of the moveable member or a space between the first internal thread of the main body and the second internal thread of the moveable member axially along the main body. Thus the nut can be fitted around and moved along the threaded fastener easily and quickly until the tightening surface of the tightening ring being pressed. Then a little bit force is applied to move the tightening ring from the open position to the closed position. The moveable member is also driven to move radially from the position away from the center of the insertion slot toward the center of the insertion slot and the curved tightening wall on the moveable member is forced to abut against and press on the threaded fastener, or the second internal thread on the moveable member is forced to engage with the external thread of the threaded fastener tightly. At the same time, the main body is also driven to move radially so that the first internal thread in the insertion slot is smoothly engaged with the external thread of the threaded fastener. Thereby the nut is threaded onto the threaded fastener. An installer only needs to turn the nut a little bit through the holding cylindrical portion by single-hand operation to achieve tightening and fastening easily and quickly. Therefore, the fastening and the operation of the fastening the nut and the threaded fastener are easy, quick, and secure and there is no need to tilt the nut during the installation and operation.

The use of the integrally formed first internal thread of the main body as the main engagement structure ensures sufficient strength and firmness of the engagement structure. It is not necessary to dispose the second internal thread on the movable member and only the curved tightening wall is required to provide radial pressing and tightening. Once the second internal thread is disposed on the movable block, the strength and the firmness of the whole engagement structure can be further improved by the second internal thread.

There is no need to tilt the nut during installation so that the present nut is especially suitable for installation and fastening of various bathroom fixtures and accessories including faucets and toilets. Not only time required for thread engagement of long threads is significantly shortened and ease of installation and operation is improved, reliable and durable installation and fastening is also achieved.

Instead of an integrally-formed part, the nut is formed by the main body, the movable member, and the tightening ring assembled with one another. The above components are made of plastic materials and produced by molding. Thus the nut has advantages of easy and quick production and lightweight design.

The nut is designed to have structures able to be held and turned conveniently by the installer such as the holding cylindrical portion and the holding surface on the holding cylindrical portion. Thereby the nut is easy to hold, turn, and operate in a labor-saving manner.

Under the state that the nut and the threaded fastener are threaded and fastened with each other, firmness and durability of the threaded structure between the nut and the threaded fastener are further improved by tightening the reinforcing fixing member of the nut. The following loosening and separation are also prevented.

The design of the tightening washer protects the surface of the object being tightened from damages. The stability and durability of the tightening effect are further improved by the evenly-distributed tightening force over larger area.

### BRIEF DESCRIPTION OF THE DRAWINGS

FIG. 1 is a perspective view of an embodiment of a nut in an open position according to the present invention;

FIG. 2 is a longitudinal section of a first side and a second side of a main body of the embodiment in FIG. 1 according to the present invention;

FIG. 3 is a longitudinal section along two reinforcing fixing members of the embodiment in FIG. 3 according to the present invention;

FIG. 4 is an exploded view of the embodiment in FIG. 1 according to the present invention;

FIG. 5 is another perspective view of a main body of the embodiment in FIG. 4 according to the present invention;

FIG. 6 is a bottom perspective view of a tightening ring of the embodiment in FIG. 4 according to the present invention;

FIG. 7 is another perspective view of a movable member of the embodiment in FIG. 4 according to the present invention;

FIG. 8 is a longitudinal section of the embodiment in FIG. 2 in which a tightening ring is moved to a close position according to the present invention;

FIG. 9 is a longitudinal section of the embodiment in FIG. 3 in which a tightening ring is moved to a close position according to the present invention;

FIG. 10 is a partially exploded sectional view of a nut of the embodiment in FIG. 1 applied to a first object and a second object according to the present invention;

FIG. 11 is a perspective view of another embodiment of a movable member in FIG. 4 according to the present invention;

FIG. 12 is a longitudinal section showing another embodiment of a resisting portion of a tightening ring in FIG. 8 according to the present invention;

FIG. 13 is an exploded view of another embodiment of a nut according to the present invention;

FIG. 14 is a longitudinal section of a nut in an open position in the embodiment of FIG. 13 along two reinforcing fixing members according to the present invention.

### DETAILED DESCRIPTION

Please refer to the following embodiments and related figures.

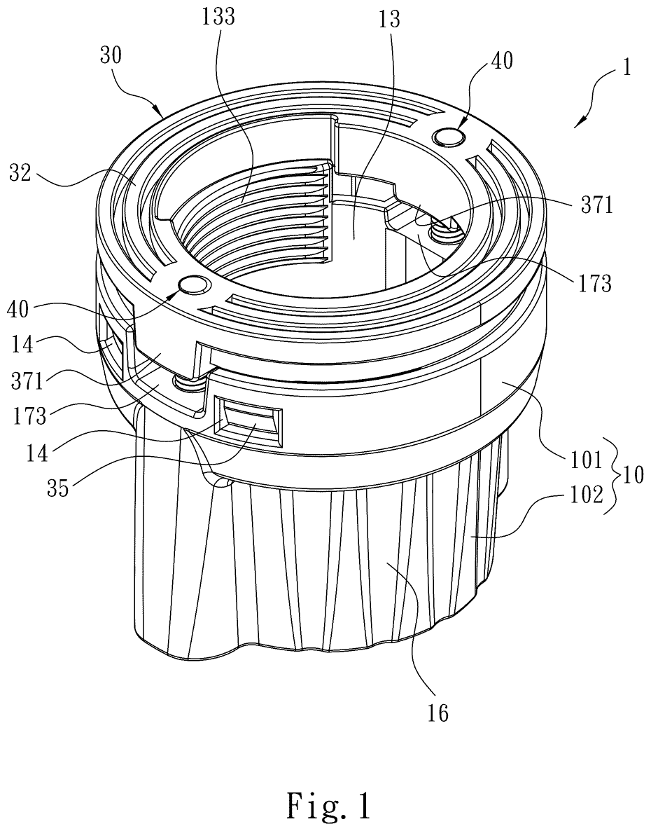

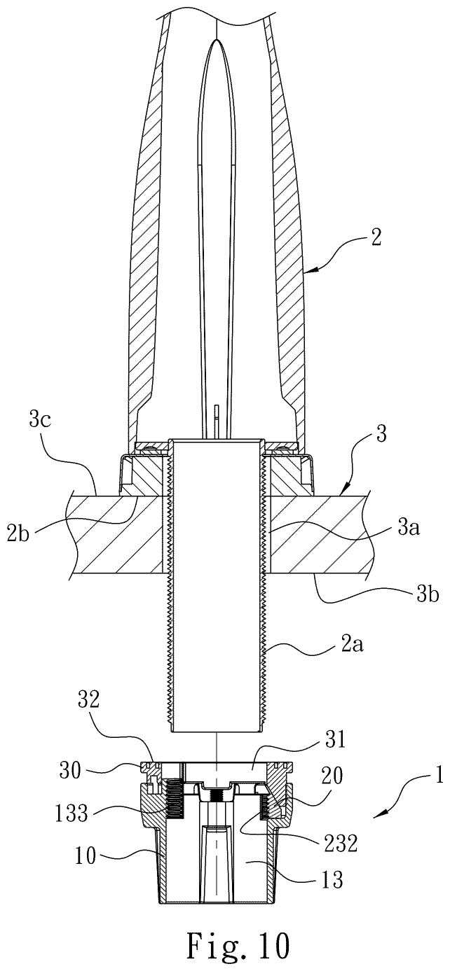

As shown in FIG. 1-10, a preferred embodiment of a quick install nut 1 is provided. The nut 1 is threaded onto a threaded fastener such as bolt, threaded rod, and threaded pipe in different forms for joining two objects or fastening the two objects on a third object quickly. As shown in FIG. 10, a first object 2 is provided with a threaded rod 2a on a bottom end. A second objects 3 is provided with at least one installation hole 3a which allows the threaded rod 2a to insert through from top to bottom. The nut 1 is quickly fit and threaded onto the threaded rod 2a and then not only abutting against a lower surface 3b of the second objects 3, but also forcing a lower surface 2b of the first object 2 to abut against and fix on an upper surface 3c of the second object 3 at the same time. Thereby the first object 2 is threaded and fastened onto the second object 3 quickly.

The first object 2 can be various faucet parts in different forms with at least one threaded rod 2a on the bottom thereof. The second object 3 is a common countertop around sink or bathtub and usually provided with at least one installation hole 3a.

The nut 1 includes a main body 10, at least one movable member 20, a tightening ring 30, and at least one reinforcing fixing member 40. The main body 10 is combined with the movable member 20 to form an engagement assembly 100 which is mainly used for allowing the threaded rod 2a to insert through and forming threaded engagement with each other.

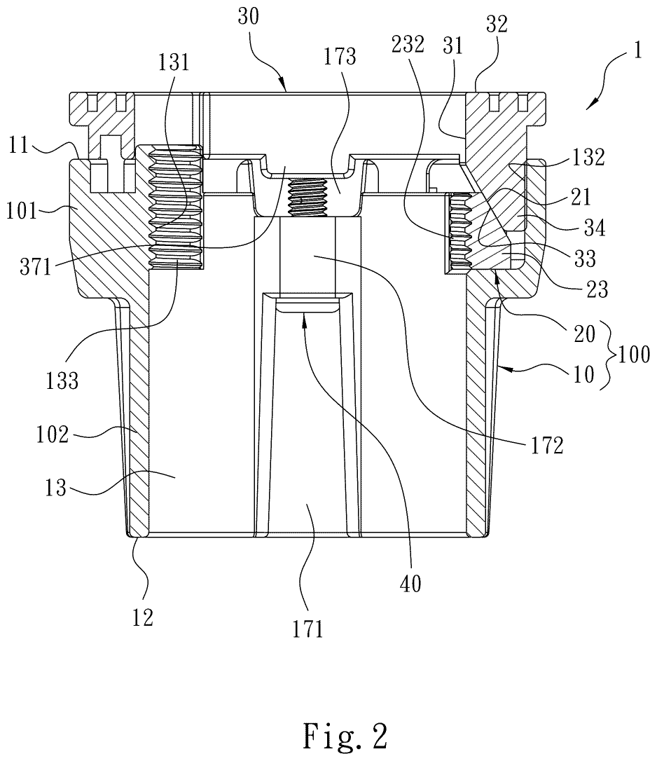

As shown in FIG. 2, the main body 10 consists of an entrance end 11, an exit end 12, and an insertion slot 13 defined in the main body 10 for allowing the threaded rod 2a to insert through.

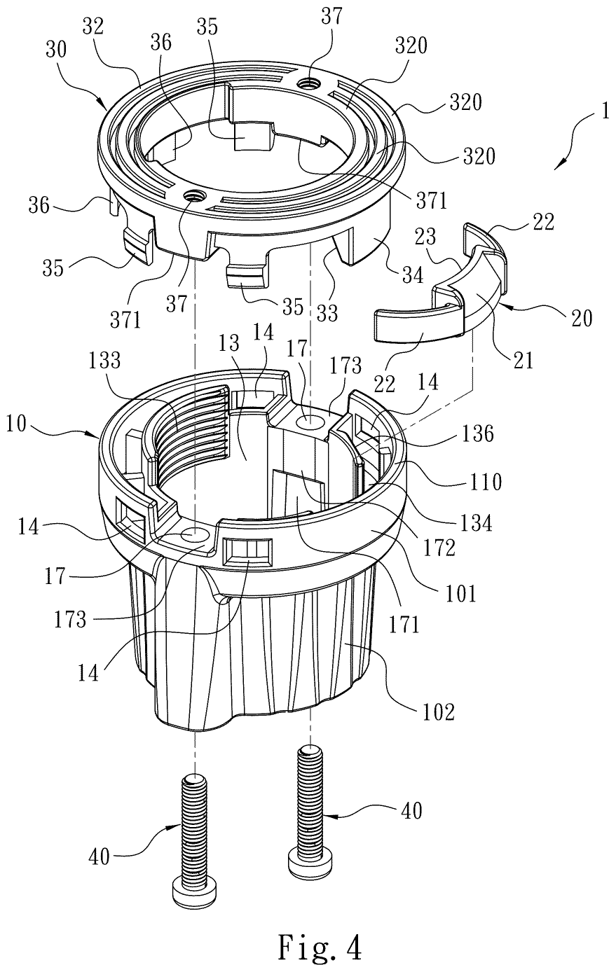

Refer to FIG. 2 and FIG. 4, the movable member 20 is mounted adjacent to the entrance end 11 of the main body 10 and able to be moved axially along the main body 10 for getting close to or away from the insertion slot 13. In this embodiment, there is only one movable member 20, but not limited. The number of the movable member 20 is not limited and there are at least two movable members 20 spaced apart from each other evenly or unevenly and moved synchronously.

As shown in FIG. 1-3, the tightening ring 30 is mounted and limited in the entrance end 11 of the main body 10 and maintained at an open position normally. While being abutted against and pressed on, the tightening ring 30 is moved from the open position to a closed position axially along the main body 10, and positioned in the closed position in an elastically recoverable manner. Then the movable member 20 is driven to move so that the threaded rod 2a is engaged in the engagement assembly 100 tightly to form a threaded structure, as shown in FIG. 2 and FIG. 10.

The reinforcing fixing member 40 is inserted through the main body 10 from the exit end 12 to the entrance end 11 and threaded with the tightening ring 30. The reinforcing fixing member 40 can be rotated and operated to protrude from the tightening ring 30 and provide pressing and tightening effect when the tightening ring 30 is in the closed position. For example, the reinforcing fixing member 40 is abutting against and pressed on the lower surface 3b of the second objects 3. It can be easily understood that a tightening force is indirectly transferred to the threaded structure formed by the engagement assembly 100 and the threaded rod 2a indirectly by the pressing and tightening effect of the reinforcing fixing member 40. Thus firmness of the threaded structure is further improved and the following loosening and releasing are also avoided. In this embodiment, there are two reinforcing fixing members 40 which can generate more even and stable pressing and tightening effect. But the number of the reinforcing fixing members 40 is not limited. Although the tightening force applied by single one reinforcing fixing member 40 is not evenly distributed, a certain but less pressing and tightening effect is still achieved.

In this embodiment, as shown in FIG. 2 and FIG. 4, a first side 131 and a second side 132 opposite to each other are mounted in the insertion slot 13 of the main body 10. A first internal thread 133 is disposed on a part of an inner peripheral wall of the insertion slot 13 and located at the first side 131 while an assembly groove 134 is arranged at the inner peripheral wall of the insertion slot 13 and located at the second side 132. The movable member 20 is mounted and positioned in the assembly groove 134 and provided with an abutted portion 21 and at least one elastic deformation portion 22 abutting against a corresponding position on the assembly groove 134. When a force is applied to the abutted portion 21, the movable member 20 is forced to move radially toward a center of the insertion slot 13 and press against the threaded rod 2a. The first internal thread 133 of the main body 10 is further driven to move radially and engage with the threaded rod 2a. At the same time, the elastic deformation portion 22 undergoes elastic deformation and produces an elastic recovery force by which the movable member 20 is radially returning to its original position and thus released and separated from the threaded rod 2a after the force applied to the abutted portion 21 being released. The first internal thread 133 of the main body 10 is also loosened and released from the threaded rod 2a, free from engagement with the threaded rod 2a simultaneously.

The tightening ring 30 consists of an opening 31, a tightening surface 32, and a resisting portion 33. The opening 31 is corresponding to the insertion slot 13, located at the entrance end 11, and allowing the threaded rod 2a to insert into the insertion slot 13 therethrough. After the tightening surface 32 being pressed, the tightening ring 30 is moved axially from the open position to the closed position and the resisting portion 33 is forced to abut against the abutted portion 21 of the movable member 20. Then the first internal thread 133 of the main body 10 is driven to engage with the threaded rod 2a.

As shown in FIG. 4, the tightening surface 32 of this embodiment is composed of a plurality of annular surfaces 320 distributed radially and partially connected, but not limited. The tightening surface 32 can be a complete annular surface.

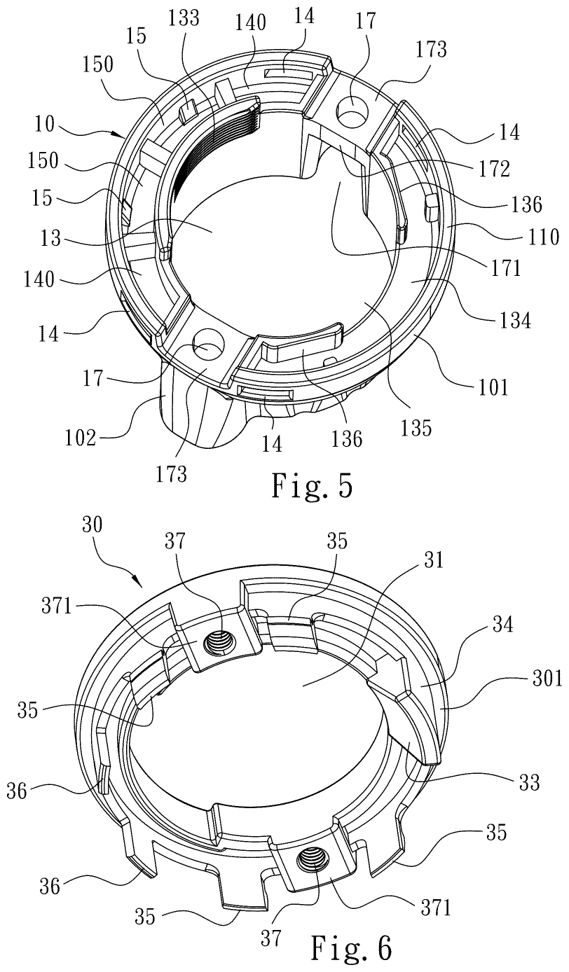

As shown in FIG. 5, FIG. 6, and FIG. 8, a bottom annular wall 301 is mounted to a bottom of the tightening ring 30. The bottom annular wall 301 of the tightening ring 30 and an upper annular edge 110 formed on top of the entrance end 11 of the main body 10 are stopped by each other for positioning the tightening ring 30 in the closed position.

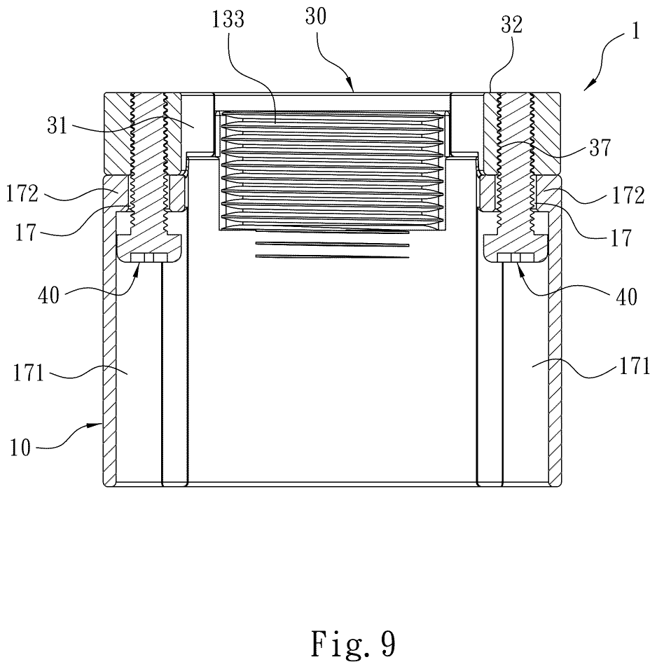

Refer to FIG. 2 and FIG. 10, it should be noted that when the tightening ring 30 is in the open position, the threaded rod 2a is allowed to insert through the opening 31 of the tightening ring 30 and the insertion slot 13 of the main body 10 quickly. During installation, the nut 1 is quickly fit around and moved along the threaded rod 2a. When the tightening surface 32 on top of the tightening ring 30 is abutting against the lower surface 3b of the second object 3, the tightening ring 30 is moved from the open position to the closed position, as shown in FIG. 8. At the moment, the movable member 20 is driven to move radially and press against an external thread of the threaded rod 2a. It is easy to understand that the main body 10 is also driven to move and the first internal thread 133 thereof is engaged with the external thread of the threaded rod 2a. Thus an engagement is generated smoothly. Thereby installers only need to turn the nut 1 a little bit for tightening, the tightening surface 32 of the tightening ring 30 is further attached to and pressed against the lower surface 3b of the second object 3 and the first objects 2 is fastened on the second object 3 quickly and firmly. Under certain circumstances or for higher requirement for fastening of the nut 1, the fastening effect is further enhanced by tightening the reinforcing fixing members 40, as shown in FIG. 9. The following loosening and releasing are also prevented.

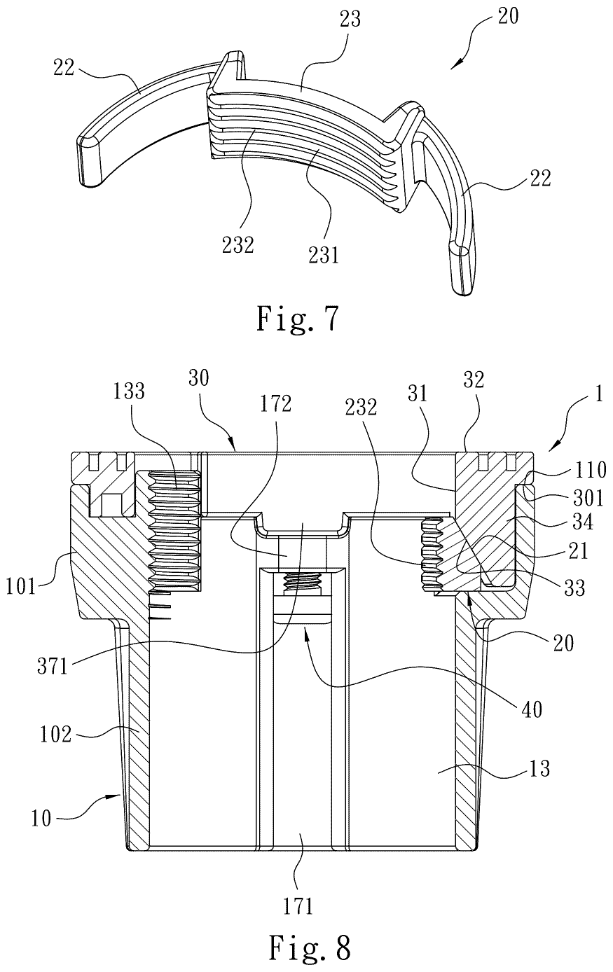

Refer to FIG. 5, a curved groove which is used to define the assembly groove 134 is disposed on the entrance end 11 of the main body 10 and located at the second side 132. The curved groove is provided with a notch 135 corresponding to the center of the insertion slot 13 and two positioning walls 136 disposed on an inner side of the curved groove and located at two lateral sides of the notch 135 correspondingly. As shown in FIG. 2 and FIG. 7, the movable member 20 is further provided with a tightening portion 23 and two elastic pieces integrally extending from two lateral sides of the tightening portion 23 correspondingly. The tightening portion 23 is provided with a curved tightening wall 231 which is formed on an inner side thereof and attached to and pressed against the external thread of the threaded rod 2a through the notch 135. The abutted portion 21 is formed on an outer side of the tightening portion 23. The elastic pieces form the elastic deformation portions 22 which are abutting against and positioned on the positioning walls 136 correspondingly.

In a preferred embodiment, a second internal thread 232 is arranged at the curved tightening wall 231 and combined with the first internal thread 133 of the cylindrical main body 10 to engage with the external thread of the threaded rod 2a firmly.

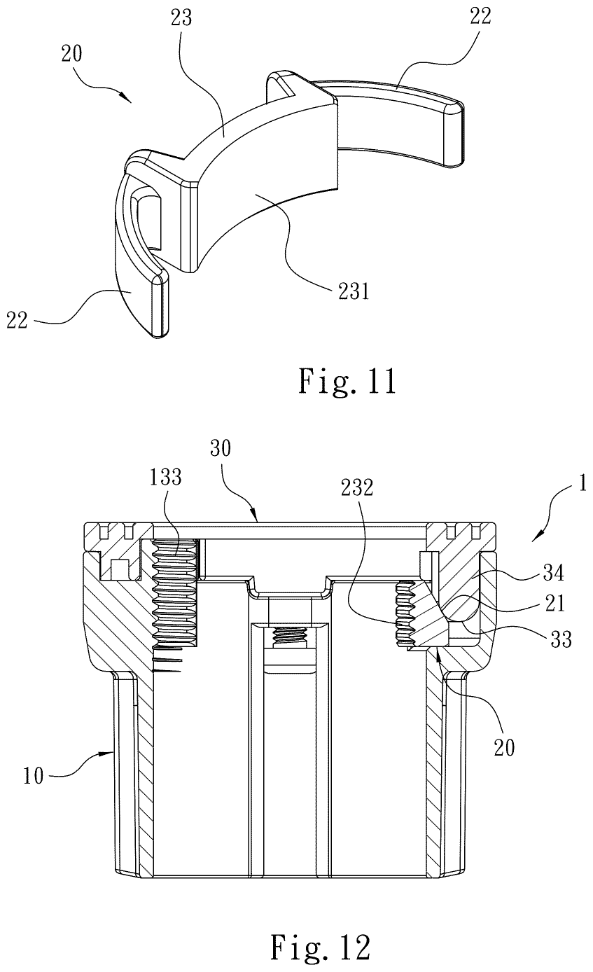

It should be noted that the main function of the movable member 20 is to apply a radial pressing tightening force to a corresponding position of the threaded rod 2a for driving the main body 10. Thus the first internal thread 133 of the main body 10 is moved radially and tightly engaged with the external thread of the threaded rod 2a to achieve secure engagement. The engagement structure is mainly formed by the first internal thread 133 and the external thread of the threaded rod 2a. As to the movable member 20, the second internal thread 232 on the movable member 20 further improves the engagement. As shown in FIG. 11, there is a smooth surface formed on the curved tightening wall and simply used for abutting and pressing against the threaded rod 2a and forcing the first internal thread 133 of the cylindrical main body 10 to engage with the external thread of the threaded rod 2a alone. The engagement required is still reached and the basic requirement is met.

In this embodiment, the abutted portion 21 of the movable member 20 is a slant. A resisting block 34 is projecting from one side of the tightening ring 30 corresponding to the main body 10 and the resisting portion 33 is disposed on the resisting block 34. The resisting portion 33 is a slant closely attached to the slant of the abutted portion 21 of the movable member 20. It is understandable that the resisting portion 33 of the resisting block 34 is not limited to the slant and able to be in other feasible shapes. For example, the resisting portion 33 is a partial spherical surface, as shown in FIG. 12.

As shown in FIG. 5 and FIG. 6, the entrance end 11 of the main body 10 is provided with a plurality of limit locking slots 14 and at least one action wall 15. The tightening ring 30 is provided with a plurality of elastic locking hooks 35 and at least one elastic pin 36. After elastic compression and deformation, the elastic locking hooks 35 are locked and limited in the limit locking slots 14 correspondingly so that the tightening ring 30 is limited to be moved between the open position and the closed position. When the tightening ring 30 is moved from the open position to the closed position, the elastic pin 36 is abutting against the action wall 15 to undergo elastic deformation and generate an elastic recovery force. By the elastic recovery force of the elastic pin 36, the tightening ring 30 is automatically returning to and positioned in the normal open position from the closed position when a tightening force acted on the tightening surface 32 of the tightening ring 30 is released.

It is understandable that in a preferred embodiment, the entrance end 11 of the main body 10 is provided with a plurality of grooves and the limit locking slots 14 and the action wall 15 are arranged at an outer surface of a wall of the grooves. Refer to FIG. 5 and FIG. 6, in this embodiment, there are four limit locking slots 14 spaced apart from each other and four elastic locking hooks 35 corresponding to the limit locking slots 14 to ensure stable and smooth assembly and movement of the main body 10 and the tightening ring 30. Two of the limit locking slots 14 are disposed on an outer wall adjacent to two lateral sides of the assembly groove 134 correspondingly and the rest two of the limit locking slots 14 are arranged at an outer wall of a first groove 140. In this embodiment, two action walls 15 with an interval therebetween and two elastic pins 36 corresponding to the action walls 15 are disposed on the first side 131 or one side of the main body 10 opposite to the side with the assembly groove 134. The action walls 15 are formed on an outer wall of a second groove 150.

In this embodiment, the elastic locking hooks 35 are abutting against corresponding positions of the limit locking slots 14 of the main body 10 to undergo elastic deformation and generate elastic recovery force when the tightening ring 30 is moved from the open position to the closed position. The function of the elastic recovery force of the elastic locking hook 35 is about the same as that of the elastic recovery force of the elastic pin 36, used to ensure the tightening ring 30 is automatically returning to and positioned in the normal open position from the closed position more smoothly when the tightening force acted on the tightening surface 32 of the tightening ring 30 is released.

As shown in FIG. 1 and FIG. 2, the main body 10 is provided with an engagement ring portion 101 and a holding cylindrical portion 102 extending from the engagement ring portion 101. The first internal thread 133, the assembly groove 134, and a part of the insertion slot 13 are formed inside the engagement ring portion 101 while the rest part of the insertion slot 13 is mounted inside the holding cylindrical portion 102 and a holding surface 16 is formed on the outside of the holding cylindrical portion 102. Users can tighten or loosen the nut 1 by holding and turning the holding surface 16.

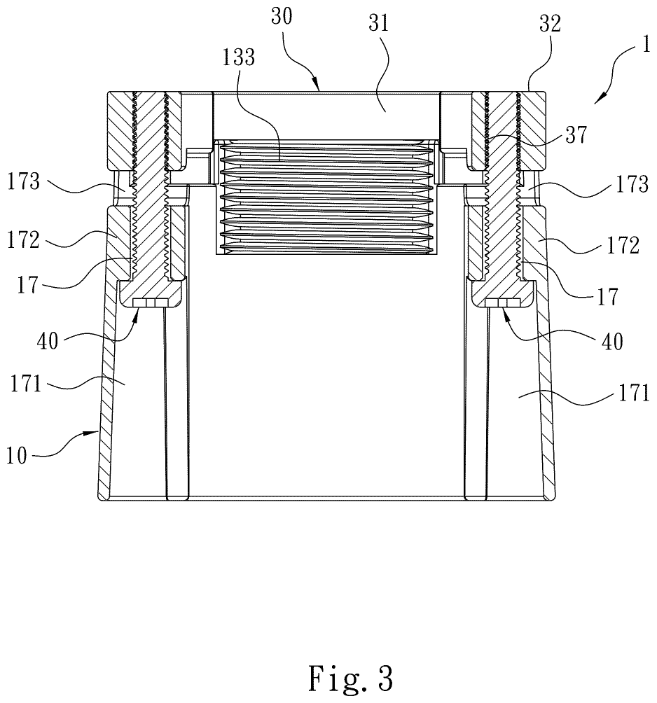

As shown in FIG. 3 and FIG. 4, the main body 10 is provided with two insertion holes 17. The tightening ring 30 is provided with two threaded holes 37 corresponding to the insertion holes 17. Two reinforcing fixing members 40 which are tightening bolts are inserted through the two insertion holes 17 from the exit end 12 of the main body 10 to be threaded with the threaded holes 37 of the tightening ring 30.

Moreover, two mounting slots 171 opposite to each other are mounted in the main body 10 and extending from the exit end 12 to the entrance end 11, and radially communicating with the insertion hole 13. One side of each of the mounting slots 171 corresponding to the entrance end 11 is connected to a base portion 172 on which the insertion hole 17 is formed. Two positioning recesses 173 opposite to each other are arranged at the entrance end 11 of the main body 10 and the insertion hole 17 is penetrating and extending to a bottom surface of the positioning recess 173, as shown in FIG. 5. Refer to FIG. 6, two positioning bumps 371 opposite to each other are projecting from one side of the tightening ring 30 corresponding to the main body 10 and mounted and positioned in the two positioning recesses 173 correspondingly. The threaded holes 37 are formed in the positioning bumps 371 correspondingly for being aligned with the insertion holes 17. It is understandable that the design of the mounting slot 171 not only helps insertion and protrusion of the reinforcing fixing member 40 but also ensures that the reinforcing fixing member 40 is properly hidden and enclosed in the main body 10 for aesthetic purposes and without in contact with foreign bodies, impurities, or water which lead to dirt, clogging, or rust. Therefore, the nut 1 can be tightened and loosened by turning in the following operation.

In a preferred embodiment, when the tightening ring 30 is in the open position, a rear end of the tightening bolt is designed to be not protruding from the tightening ring 30 and the purpose of such design is to ensure the tightening ring 30 is able to perform pressing and tightening by the tightening surface 32, instead of the tightening bolts. Thereby when the tightening ring 30 is in the closed position, the tightening bolt is turned and the rear end of the tightening bolt is protruding from the tightening ring 30 to achieve pressing and tightening effect. In other words, the tightening bolt will not affect the installation of the nut 1 before the installer turning and tightening the tightening bolt, especially the threading of the nut 1. The installer can determine whether to tighten the tightening bolt or not flexibly according to site conditions.

As shown in FIG. 2 and FIG. 4, it is learned that the tightening ring 30 of the nut 1 is in the open position normally. Thus the moveable member 20 is affected by positioning of the elastic deformation portions 22 on the two lateral sides thereof to be away from the center of the insertion slot 13 of the main body 10. During installation, the threaded rod 2a is allowed to be quickly inserted through a space between the first internal thread 133 of the main body 10 and the curved tightening wall 231 of the moveable member 20 or a space between the first internal thread 133 of the main body 10 and the second internal thread 232 of the moveable member 20 axially along the main body 10, as shown in FIG. 10. In other words, the nut 1 can be fitted around and moved along the threaded rod 2a easily and quickly until the tightening surface 32 of the tightening ring 30 is abutting against and in contact with the lower surface 3b of the second object 3. Then a little bit force is applied to move the tightening ring 30 from the open position to the closed position. At the moment, the moveable member 20 is driven to move radially from the position away from the center of the insertion slot 13 toward the center of the insertion slot 13 and the curved tightening wall 231 on the moveable member 20 is forced to abut against and press on the external thread of the threaded rod 2a, or the second internal thread 232 on the moveable member 20 is forced to engage with the external thread of the threaded rod 2a tightly. At the same time, the cylindrical main body 10 is also driven to move radially so that the first internal thread 133 in the cylindrical slot 13 is smoothly engaged with the external thread of the threaded rod 2a. Thereby the nut 1 is threaded onto the threaded rod 2a.

The installer only needs to turn the nut 1 a little bit through the holding cylindrical portion 102 by single-hand operation to achieve tightening and fastening easily and quickly and the first object 2 is smoothly fastened on the third object 3. Therefore, the fastening and the operation of the fastening the nut 1 and the threaded rod 2a are easy, quick, and secure and there is no need to tilt the nut 1 during the operation.

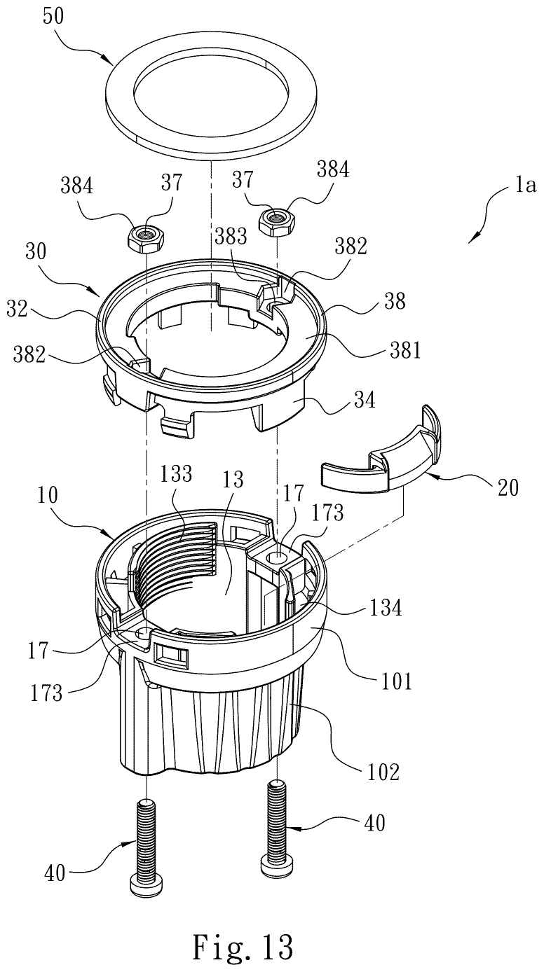

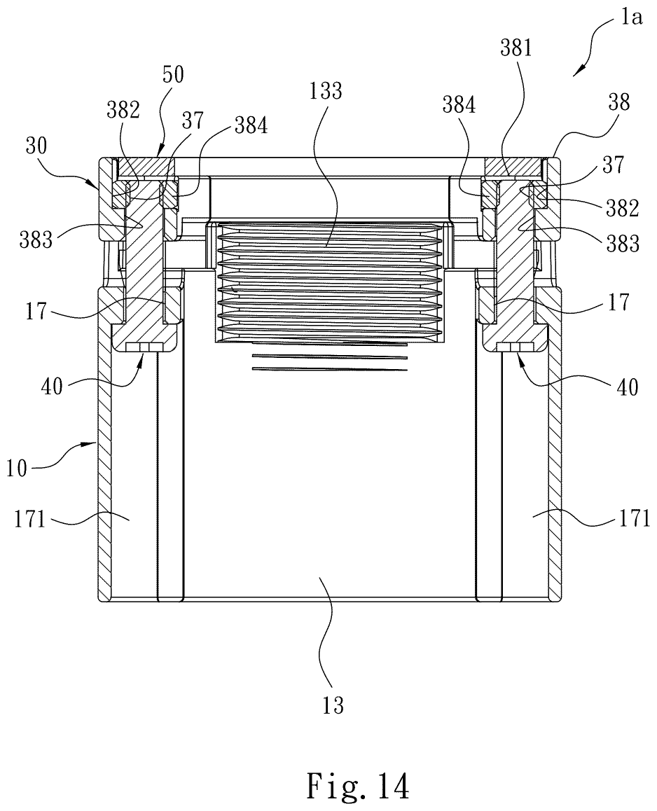

As shown in FIG. 13, FIG. 14, another embodiment of a quick install nut is provided. A nut 1a of this embodiment is about the same as the nut 1 of the first embodiment and only different in that the nut 1a of this embodiment further includes a tightening washer 50 mounted and positioned on the tightening ring 30. After being turned, the reinforcing fixing member 40 is inserted through and protruding from the tightening ring 30 to abut and press against the tightening washer 50. Then a pressing and tightening effect is generated by the tightening washer 50.

It is easily understood that the design of the tightening washer 50 can prevent the reinforcing fixing member 40 from damaging the lower surface 3b due to too much concentrated tightening force when the reinforcing fixing member 40 is directly abutting against the lower surface 3b of the second object 3. Besides prevention of possible damages to the lower surface 3b, the tightening force is more dispersed and distributed evenly so that the tightening effect is more stable and firm.

The tightening ring 30 is provided with an annular flange 38 and the tightening surface 32 is disposed on a top surface of the annular flange 38. A positioning annular groove 381 is defined in the annular flange 38 for mounting and positioning the tightening washer 50 therein. The threaded holes 37 are formed on a bottom wall of the positioning annular groove 381.

Two nut positioning slots 382 opposite to each other are concavely mounted to the bottom wall of the positioning annular groove 381 and two through holes 383 are penetrating the two nut positioning slots 382 correspondingly. Two nuts 384 are mounted and positioned in the nut positioning slots 382 correspondingly with limited rotation and used to form the threaded holes 37 correspondingly. Thereby in this embodiment, the threaded hole 37 is formed by the nut 384 pre-mounted in the tightening ring 30, but not limited. The threaded hole 37 can also be integrally formed as that in the above embodiment.

It should be noted that there is only a single movable member 20 in the above two embodiments. During installation and application of the reinforcing fixing member 40, the number of the movable member 20 is not limited and there can be at least two movable members 20. Under such condition, the main body 10 provides no engagement or threaded connection. A threaded assembly is formed completely by the movable members 20 synchronously moved toward the threaded rod 2a and engaged with the threaded rod 2a tightly. The structure with similar designs should be covered in the scope of protection of the present invention.

In the above embodiments, the use of the integrally formed first internal thread 133 of the main body 10 as the main engagement structure ensures sufficient strength and firmness of the engagement structure. It is not necessary to dispose the second internal thread 232 at the movable member 20 and only the curved tightening wall 231 is required to provide radial pressing and tightening. Once the second internal thread 232 is arranged at the movable member 20, the strength and the firmness of the whole engagement structure can be further improved by the second internal thread 232.

There is no need to tilt the nut 1. 1a during installation so that the present nut 1, 1a is especially suitable for installation and fastening of various bathroom fixtures and accessories including faucets and toilets. Not only time required for thread engagement of long threads is significantly shortened and ease of installation and operation is improved, reliable and durable installation and fastening is also achieved.

Instead of an integrally-formed part, the nut 1, 1a is formed by the main body 10, the movable member 20, and the tightening ring 30 assembled with one another. The above components are made of plastic materials and produced by molding. Thus the nut 1, 1a has advantages of easy and quick production and lightweight design.

The nut 1, 1a is designed to have structures able to be held and turned conveniently by the installer such as the holding cylindrical portion 102 and the holding surface 16 on the holding cylindrical portion 102. Thereby the nut 1 is easy to hold, turn, and operate in a labor-saving manner.

Under the state that the nut 1, 1a and the threaded rod 2a are threaded and fastened with each other, firmness and durability of the threaded structure between the nut 1, 1a and the threaded rod 2a are further improved by tightening the reinforcing fixing member 40. The following loosening and separation are also prevented.

In the nut 1a, the design of the tightening washer 50 protects the surface of the object being tightened such as the lower surface 3b of the second objects 3 from damages. The stability and durability of the tightening effect are further improved by the evenly-distributed tightening force over larger area.

Additional advantages and modifications will readily occur to those skilled in the art. Therefore, the invention in its broader aspects is not limited to the specific details, and representative devices shown and described herein. Accordingly, various modifications may be made.

1. A quick install nut comprising:
an engagement assembly provided with a main body and at least one movable member; the main body having an entrance end, an exit end, and an insertion slot defined in the main body for allowing a threaded fastener to insert through; the movable member mounted adjacent to the entrance end of the main body and moved axially along the main body to be close to or away from the insertion slot;
a tightening ring mounted and limited in the entrance end of the main body and maintained at an open position normally; While being abutted against and pressed on, the tightening ring moved from the open position to a closed position axially along the main body and positioned in the closed position in an elastically recoverable manner; the movable member is further driven to move so that the threaded fastener is engaged in the engagement assembly to form a threaded structure; and
at least one reinforcing fixing member inserted through the main body from the exit end to the entrance end and threaded with the tightening ring; the reinforcing fixing member able to be turned and operated to protrude from the tightening ring and generate a pressing and tightening effect when the tightening ring is in the closed position.

2. The quick install nut as claimed in claim 1, wherein a first side and a second side opposite to each other are mounted in the insertion slot of the main body; a first internal thread is disposed on a part of an inner peripheral wall of the insertion slot and located at the first side while an assembly groove is arranged at the inner peripheral wall of the insertion slot and located at the second side; the movable member is mounted and positioned in the assembly groove and provided with an abutted portion and at least one elastic deformation portion abutting against the assembly groove; when a force is applied to the abutted portion, the movable member is forced to move radially toward a center of the insertion slot and press against the threaded fastener; the first internal thread of the main body is further driven to move radially and engage with the threaded fastener; the elastic deformation portion undergoes elastic deformation and produces an elastic recovery force simultaneously.

3. The quick install nut as claimed in claim 2, wherein the tightening ring is provided with an opening, a tightening surface, and a resisting portion; the opening is corresponding to the insertion slot at the entrance end and allowing the threaded fastener to insert into the insertion slot therethrough; the tightening ring is moved axially from the open position to the closed position and the resisting portion is forced to abut against the abutted portion of the movable member after the tightening surface being pressed; the first internal thread of the main body is further driven to engage with the threaded fastener.

4. The quick install nut as claimed in claim 2, wherein a curved groove used to define the assembly groove is disposed on the entrance end of the main body and located at the second side; the curved groove is provided with a notch corresponding to the center of the insertion slot and two positioning walls disposed on an inner side of the curved groove and located at two lateral sides of the notch correspondingly; the movable member is further provided with a tightening portion and two elastic pieces integrally extending from two lateral sides of the tightening portion correspondingly; the tightening portion is provided with a curved tightening wall which is formed on an inner side thereof and attached to and pressed against an external thread of the threaded fastener through the notch; the abutted portion is formed on an outer side of the tightening portion; the elastic pieces form the elastic deformation portions which are abutting against and positioned on the positioning walls correspondingly.

5. The quick install nut as claimed in claim 4, wherein a second internal thread is arranged at the curved tightening wall and combined with the first internal thread of the main body to engage with the external thread of the threaded fastener securely.

6. The quick install nut as claimed in claim 4, wherein the curved tightening wall is a smooth surface used for abutting and pressing against the external thread of the threaded fastener and forcing the first internal thread of the main body to engage with the external thread of the threaded fastener alone.

7. The quick install nut as claimed in claim 3, wherein the abutted portion of the movable member is a slant; a resisting block is projecting from one side of the tightening ring corresponding to the main body and the resisting portion is disposed on the resisting block; the resisting portion is a slant closely attached to the slant of the abutted portion of the movable member.

8. The quick install nut as claimed in claim 3, wherein the abutted portion of the movable member is a slant; a resisting block is projecting from one side of the tightening ring corresponding to the main body and the resisting portion is disposed on the resisting block; the resisting portion is a partial spherical surface.

9. The quick install nut as claimed in claim 4, wherein the entrance end of the main body is provided with a plurality of limit locking slots and at least one action wall; the tightening ring is provided with a plurality of elastic locking hooks and at least one elastic pin; after elastic compression and deformation, the elastic locking hooks are locked and limited in the limit locking slots correspondingly so that the tightening ring is limited to be moved between the open position and the closed position; the elastic pin is abutting against the action wall to undergo elastic deformation and generate an elastic recovery force when the tightening ring is moved from the open position to the closed position.

10. The quick install nut as claimed in claim 9, wherein the elastic locking hooks of the tightening ring are abutting against the limit locking slots of the main body to undergo elastic deformation and generate an elastic recovery force when the tightening ring is moved from the open position to the closed position.

11. The quick install nut as claimed in claim 2, wherein the main body is provided with an engagement ring portion and a holding cylindrical portion extending from the engagement ring portion; the first internal thread, the assembly groove, and a part of the insertion slot are formed inside the engagement ring portion while the rest part of the insertion slot is mounted inside the holding cylindrical portion and a holding surface is formed on the outside of the holding cylindrical portion for users to hold and operate.

12. The quick install nut as claimed in claim 3, wherein the main body is provided with two insertion holes; the tightening ring is provided with two threaded holes corresponding to the insertion holes; two tightening bolts which form the two reinforcing fixing members correspondingly are inserted through the insertion holes from the exit end of the main body to be threaded with the threaded holes of the tightening ring.

13. The quick install nut as claimed in claim 12, wherein two mounting slots opposite to each other are mounted in the main body, extending from the exit end to the entrance end, and radially communicating with the insertion hole; one side of each of the mounting slots corresponding to the entrance end is connected to a base portion on which the insertion hole is formed; two positioning recesses opposite to each other are arranged at the entrance end of the main body and the insertion hole is penetrating and extending to a bottom surface of the corresponding positioning recess; two positioning bumps opposite to each other are projecting from one side of the tightening ring corresponding to the main body and mounted and positioned in the two positioning recesses correspondingly; the threaded holes are disposed on the positioning bumps correspondingly for being aligned with the insertion holes.

14. The quick install nut as claimed in claim 12, wherein a rear end of the tightening bolt is not protruding from the tightening ring when the tightening ring is in the open position; the tightening bolt is tightened so that the rear end of the tightening bolt is protruding from the tightening ring for generating the pressing and tightening effect when the tightening ring is in the closed position.

15. The quick install nut as claimed in claim 1, wherein the quick install nut further includes a tightening washer mounted and positioned on the tightening ring; when the reinforcing fixing member is turned and operated to insert through and protrude from the tightening ring, the reinforcing fixing member is abutting and pressing against the tightening washer so that a pressing and tightening effect is generated by the tightening washer.

16. The quick install nut as claimed in claim 12, wherein the quick install nut further includes a tightening washer which is provided with an annular flange and the tightening surface is disposed on the annular flange; a positioning annular groove is defined in the annular flange for mounting and positioning the tightening washer therein; the threaded holes are mounted to a bottom wall of the positioning annular groove.

17. The quick install nut as claimed in claim 16, wherein two nut positioning slots opposite to each other are mounted to the bottom wall of the positioning annular groove and two through holes are penetrating the two nut positioning slots correspondingly; two nuts with limited rotation are mounted and positioned in the nut positioning slots correspondingly and used to form the threaded holes.
